(19) United States
(12) Patent Application Publication
(10) Pub. No.: US 2026/0120119 A1
(43) Pub. Date: Apr. 30, 2026

(54) SYSTEMS AND METHODS FOR ENSURING COMPLIANCE OF AGRICULTURAL PROGRAMS

(71) Applicant: Climate LLC, St. Louis, MO (US)

(72) Inventor: Michael Perlmutter, Chesterfield, MO (US)

(21) Appl. No.: 19/368,216

(22) Filed: Oct. 24, 2025

Related U.S. Application Data
(60) Provisional application No. 63/711,356, filed on Oct. 24, 2024.

(51) Int. Cl. G06Q 30/018

(52) U.S. Cl. CPC G06Q 30/018

(57) ABSTRACT

Systems and methods for monitoring compliance of an agricultural program are disclosed. In one embodiment, a computer-implemented method may include receiving a ruleset corresponding to the agricultural program, receiving first activity and/or location data from at least one of one or more agricultural implements, through a communication interface communicatively coupled with the at least one processor and configured to enable communication between the at least one processor and the one or more agricultural implements, comparing the first activity and/or location data against the ruleset to determine whether the at least one of the one or more agricultural implements is in compliance with the agricultural program, and transmitting a command to the at least one of the one or more agricultural implements to generate an alert when the at least one of the one or more agricultural implements is determined to be out of compliance.

### CROSS-REFERENCE TO RELATED APPLICATION

This application claims the benefit of, and priority to, U.S. Provisional Patent Application No. 63/711,356, filed on October 24, 2024. The entire disclosure of the above application is incorporated herein by reference.

### FIELD

The present disclosure generally relates to systems and methods for implementing agricultural programs, and more specifically to systems and methods that monitor activities of agricultural implements and personnel to ensure compliance under the agricultural programs and activities.

### BACKGROUND

This section provides background information related to the present disclosure which is not necessarily prior art.

As agricultural implements (e.g., tractors, harvesters, etc.) have become increasingly automated, prescriptive agricultural programs have become increasingly common. A farmer or grower may enroll in an agricultural program that dictates certain agricultural practices. In exchange, the grower may obtain some benefit. For example, the agricultural program may be a carbon credits program. The program may require the grower to engage in one or more climate-friendly or eco-friendly practices, e.g., no-till, cover crop planting, in exchange for carbon credits that the grower can later sell. Another agricultural program example is the Delaro® Performance Showcase from Bayer Crop Science^{TM}. In the Delaro® Showcase program, once enrolled, the grower applies Delaro® fungicide once per season and manages a trial comparison area that functions as an untreated check strip so that the health of treated versus untreated crops can be compared. Agricultural programs may also be self-imposed. For example, a grower may impose a program upon him or herself to spray no more pesticides than a certain threshold, in order to control costs. Agricultural programs may also be advised/selected to conform with best practices or label restrictions. For example, a grower may select and adjust pre-defined application rules for a crop protection product based on guidelines from the product label.

However, improved ways to monitor agricultural activities to ensure compliance under the agricultural programs are needed. For example, if a grower is enrolled in a carbon credits program, to qualify for credits, the grower may have to plant a certain number of cover crops. Conventionally, the number of cover crops planted may be self-reported by the grower. For example, the grower may input the number of cover crops planted in a webform hosted by the carbon credits program administrator. However, this system of self-reporting is inconvenient to the grower, prone to errors, and vulnerable to abuse. Therefore, there exists a need in the art for a system that can automatically monitor agricultural activities to ensure compliance under agricultural programs.

### SUMMARY

This section provides a general summary of the disclosure and is not a comprehensive disclosure of its full scope or all of its features.

Example embodiments of the present disclosure generally relate to computer-implemented methods for use in monitoring activities of agricultural implements to ensure compliance under agricultural programs. In one example embodiment, such a method includes receiving a ruleset corresponding to the agricultural program and storing the ruleset in a memory communicatively coupled to at least one processor; receiving first activity and/or location data from at least one of one or more agricultural implements, through a communication interface communicatively coupled with the at least one processor and configured to enable communication between the at least one processor and the one or more agricultural implements; comparing the first activity and/or location data against the ruleset to determine whether the at least one of the one or more agricultural implements is in compliance with the agricultural program; and transmitting a command to the at least one of the one or more agricultural implements to generate an alert when the at least one of the one or more agricultural implements is determined to be out of compliance.

Example embodiments of the present disclosure generally relate to systems for use in monitoring activities of agricultural implements to ensure compliance under agricultural programs. In one example embodiment, such a system generally includes at least one first processor, a communication interface communicatively coupled with the at least one first processor and configured to enable communication between the at least one first processor and one or more agricultural implements, and a first memory communicatively coupled to the at least one first processor. The first memory may store executable instructions, which when executed by the at least one first processor, cause the at least one first processor to: receive a ruleset corresponding to the agricultural program; receive first activity and/or location data from at least one of the one or more agricultural implements; compare the first activity and/or location data against the ruleset to determine whether the at least one of the one or more agricultural implements is in compliance with the agricultural program; and transmit a command to the at least one of the one or more agricultural implements to generate an alert when the at least one of the one or more agricultural implements is determined to be out of compliance.

Example embodiments of the present disclosure also generally relate to non-transitory computer readable storage media including computer-executable instructions for use in monitoring activities of agricultural implements to ensure compliance under agricultural programs, which when executed by at least one processor, cause the at least one processor to perform one or more of the above operations.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates an example system for use in monitoring activities of agricultural implements to ensure compliance under agricultural programs and providing alerts when out of compliance;

FIG. 2A and FIG. 2B each illustrate an example logical organization of sets of instructions in main memory of a computing device, when an example application is loaded on the computing device for execution, which may be used in connection with the system of FIG. 1; and

FIG. 3 is a block diagram that illustrates a computing device (or computer system) upon which embodiments of the system of FIG. 1 may be implemented.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

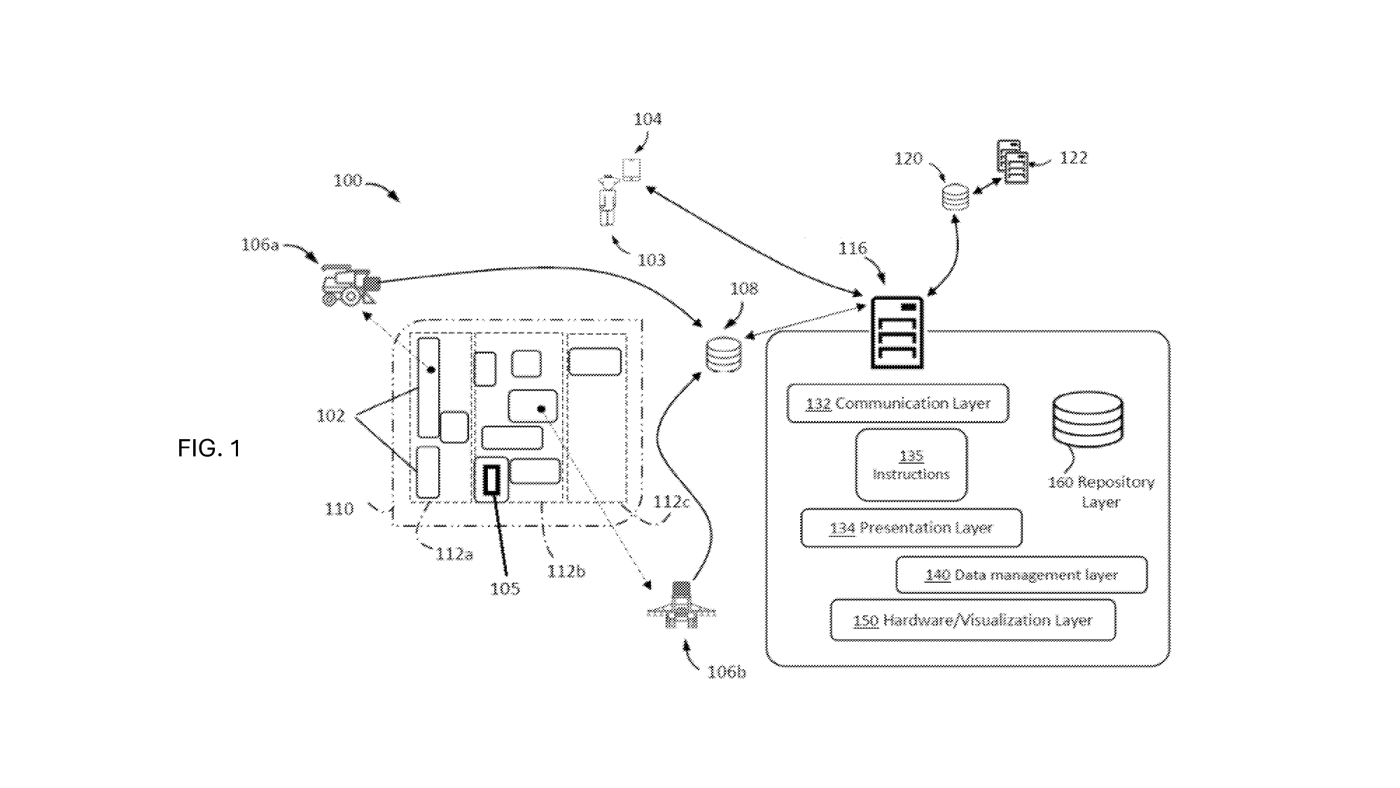

FIG. 1 illustrates an example system 100 in which one or more aspect(s) of the present disclosure may be implemented. Although the system 100 is presented in one arrangement, other embodiments may include the parts of the system 100 (or other parts) arranged otherwise depending on, for example, types of crops; types of crop diseases present in growing spaces; types and/or locations of growing spaces; the nature of the agricultural practice and ruleset; and/or privacy and/or data requirements; etc.

The system 100 generally includes various growing spaces (e.g., plots 102, etc.), for example, associated with a user 103 (e.g., a grower, etc.). The plots 102 are shown in solid lines in FIG. 1 within region 110.

As shown in FIG. 1, the plots 102 are included within the region 110, and are further organized (or separated, etc.) into different fields 112a-c (which are also included within the region 110). The region 110 and fields 112a-c are represented by dotted lines. The region 110 in turn may include and/or may be defined by postal codes, area codes, counties, a group of counties, a state, a group of states, territories, a group of territories, a country, a group of countries, or other geo-political boundaries or non-geo-political boundaries (e.g., a watershed, a group of watersheds, a maturity band, a group of maturity bands, etc.), etc. It should be appreciated that other system embodiments may include hundreds or thousands, or more or less, plots, and tens, hundreds or thousands of fields, regions, etc.

In the illustrated embodiment, the plots 102 may be part of any type of field in which crops are grown and harvested. The plots 102 may be owned by the user 103, or otherwise operated and/or managed by the user 103, for example, in the business of growing, harvesting, and selling crops. In connection therewith, the user 103 may alter conditions of the plots 102, as the seeds grow into plants (e.g., in season, etc.) (e.g., through treatments, irrigation, etc.), and then harvest the crops with a variety of different farm equipment (e.g., combines, pickers, etc.) (as explained below).

As shown in FIG. 1, a particular plot 102 may further include a control region 105. As explained above, in certain agricultural programs, the grower may be required to set up a control region 105 in order to enable a comparison. In this case, the portion of the plot 102 outside the control region 105 would be, for example, the treatment region where a pesticide or fungicide is applied. Such a portion of the plot 102 outside the control region 105 may be referred to as an “activity region.” To comply with the agricultural program, the grower may apply the pesticide or fungicide in the treatment region and grow the same crop without the pesticide or fungicide in the control region 105. At the end of the season, the grower may compare the health or yield in the treatment and control regions. The boundaries of the region 110, the fields 112a-c, the plots 102, and the control regions 105 may be defined and stored electronically (e.g., as numerical longitudes and latitudes, as GPS coordinates, etc.) in the agricultural computer system 116 or another component of the system (e.g., the data server 108).

In connection with the above, data (e.g., agronomic data, etc.) is gathered at or from the plots 102. The data may be gathered manually, or automatically, for example, by farm equipment, etc. The data may include plant/seed identifiers, plant/seed types, crop disease identifiers and/or types, crop disease presence observations, crop disease severity observations (e.g., on a scale of severity), observation dates, planting dates, growing temperature days, location data, field identifiers, soil conditions (e.g., moisture, drainage, etc.), plant performance (e.g., height, strength, yield, etc.) (e.g., at one or more regular or irregular interval(s), etc.), plant growth stages, treatments, weather conditions (e.g., precipitation, temperature, humidity, etc.), field topology (e.g., elevation, change in slope, surrounding terrain, etc.), management practices (e.g., crop rotation, fungicide application, tiling, etc.), and other suitable data to identify the seed/plant, a performance of the seed/plant, crop diseases associated with the seed/plant, etc., in the plots 102.

Although data are described in some example embodiments with reference to the plots 102, it should be appreciated that data may be gathered at the field level (e.g., for one plot or more than one plot, etc.), at a region level (e.g., for multiple fields and multiple plots, etc.), etc., and may be broadly referred to as gathered for the growing spaces (where the growing spaces may be at the plot level, at the field level, etc.).

With continued reference to FIG. 1, the system 100 also includes farm equipment 106a-b (e.g., agricultural machines, etc.), a data server 108 (or multiple data servers), and an agricultural computer system 116, each of which is coupled to (and is in communication with) one or more network(s). The network(s) is/are indicated generally by arrowed lines in FIG. 1, and may each include, without limitation, one or more of a local area network (LAN), a wide area network (WAN) (e.g., the Internet, etc.), a mobile/cellular network, a virtual network, and/or another suitable public and/or private network capable of supporting communication among parts of the system 100 illustrated in FIG. 1, or any combination thereof.

In this example embodiment, the farm equipment 106a-b may include, without limitation, one or more harvesting devices, sprayers, planters, etc. As shown in FIG. 1, for example, the farm equipment 106a may include, for example, a combine, a picker, or other mechanism for harvesting plants/crops, etc., while the farm equipment 106b may include a sprayer or other mechanism for delivering a desired treatment to plants/crops in the plots 102. Additionally, or alternatively, the farm equipment 106a-b may include planters, tillers, irrigators, or other suitable equipment, configured to carry out one or more operations at the plots 102, such as, for example, application of treatments, irrigation, etc.

It should also be appreciated that a different number and/or type of farm equipment, which may be distributed differently among the different plots 102, may be included in other system embodiments.

The farm equipment 106a-b is also configured to measure, capture, or identify data, and additionally to compile data, which are specific to the crop and/or plots 102 as the equipment is performing the defined task related to the crop or plot 102, etc. The data may include, without limitation, rates, soil compositions, times, dates, yield, weights, applications, moisture content, volumes, flow, or other suitable data, etc., relating to treatments, irrigation, harvested crops, etc. Moreover, in this example, the farm equipment 106a-b may be configured to track their locations at given times, as each traverses the plots 102, as expressed in latitude/longitude coordinates, or otherwise, and to correlate the locations to other data gathered/compiled by the farm equipment 106a-b (e.g., permitting the data to be correlated to a specific plant and/or seed based on planting data for the growing spaces, etc.).

As indicated above, the farm equipment 106a-b may be configured to measure, capture, or identify soil information, such as a soil moisture content, drainage level, etc. In one example, the farm equipment 106a-b may include one or more instruments for measuring a current moisture level of the soil, for measuring a rate of water drainage from the soil over time, etc. Additionally, or alternatively, the plots 102 may include one or more instruments disposed therein for measuring soil conditions to generate soil data, whereby the user 103 and/or soil investigator may obtain the soil data therefrom at one or more regular or irregular intervals, etc.

The farm equipment 106a-b and/or computing devices associated with the user 103 and/or investigator(s) (e.g., communication device 104, etc.) may be further configured to transmit the gathered data to the data server 108. That said, a different number of data servers may be included in other system embodiments, with the different data servers each potentially being specific to certain ones (or more) of the plots 102 or fields or regions, etc.

The data server 108, in turn, is configured to store the received data in one or more data structures. In general, in this example embodiment, the data server 108 is configured to store data by year (e.g., Year_X, Year_X+1, etc.), which corresponds to the different growing years (e.g., 2015, 2016, 2017, etc.) for the plots 102 (and/or trials, plots, fields, etc. within the growing spaces, etc.). Then, for each year and for each of the plots/fields/growing spaces included, the data may include, for example (and without limitation), presence and severity of multiple different crop disease types (such as, for example, an integer severity scale), performance, identifier, brands for seeds, relative maturity, planting dates, growing temperature days, growing mode of action, prior crops, types of traits or trait stacks, treatments, positions/distributions of seeds in the plots 102 (e.g., seeding rates, etc.), location definitions of the plots 102 or of seeds within the plots 102 (e.g., field boundaries, latitude and longitude, centroid of a plot or other boundary, etc.), acreage of the growing spaces, populations of seeds planted in the plots 102, yields and harvest moisture (e.g., based on location and seed products, etc.), etc. The data may also include soil conditions (e.g., soil moisture, drainage levels, etc.), field elevations (which may include slopes of a plot, surrounding terrain information, etc.), precipitation amounts, relative humidity, temperature, solar radiation, irrigation amounts, management practices (e.g., crop rotation, fungicide application, tiling, drainage, etc.) or any other data indicative of the growing conditions for the seeds/plants in the given plots 102, etc.

It should be appreciated that any available and/or desired data may be collected with regard to the plots 102 and/or the crops planted therein. What’s more, the data included in data structure(s) of the data server 108 may be augmented with additional information about the crops and/or plots 102 from one or more other sources, including, for example, weather data, treatment data sheets, the Environmental Protection Agency’s (“EPA”) Pesticide Use Limitation Areas (“PULA”) designations and/or details, boundary data (e.g., boundary definitions, centroids, etc.), field topology data, crop disease type data, etc.

With further reference to FIG. 1, the user 103 (again, for example, a grower, a sales representative, another user, etc.) in the system 100 may own, operate, or possess the communication device 104 (e.g., as a field manager computing device, etc.) in a growing location or associated with a growing location (e.g., one or more of the growing locations or plots 102, etc.), such as a field intended for agricultural activities or a management location for one or more agricultural fields. The communication device 104 is programmed, or configured, to provide field data to the agricultural computer system 116 via one or more networks (as indicated by arrowed lines in FIG. 1) (e.g., for use in identifying characteristics of a target field of the growing spaces, etc.). Again, the network(s) may each include, without limitation, one or more of local area networks (LANs), wide area networks (WANs) (e.g., the Internet, etc.), mobile/cellular networks, virtual networks, and/or other suitable public and/or private networks capable of supporting communication among parts of the system 100 illustrated in FIG. 1, or any combination thereof.

Examples of field data may include, for example, (a) identification data (for example, acreage, field name, field identifiers, geographic identifiers, boundary identifiers, crop identifiers, and any other suitable data that may be used to identify farmland, such as a common land unit (CLU), lot and block number, a parcel number, geographic coordinates and boundaries, Farm Serial Number (FSN), farm number, tract number, field number, section, township, and/or range), (b) harvest data (for example, crop type, crop variety, crop rotation, whether the crop is grown organically, harvest date, Actual Production History (APH), expected yield, yield, crop price, crop revenue, grain moisture, tillage practice, and previous growing season information), (c) soil data (for example, type, composition, pH, organic matter (OM), cation exchange capacity (CEC)), (d) planting data (for example, planting date, seed(s) type, relative maturity (RM) of planted seed(s), seed population), (e) fertilizer data (for example, nutrient type (Nitrogen, Phosphorus, Potassium), application type, application date, amount, source, method), (f) chemical application data (for example, pesticide, herbicide, fungicide, other substance or mixture of substances intended for use as a plant regulator, defoliant, or desiccant, application date, amount, source, method), (g) irrigation data (for example, application date, amount, source, method), (h) weather data (for example, precipitation, rainfall rate, predicted rainfall, water runoff rate region, temperature, wind, forecast, pressure, visibility, clouds, heat index, dew point, humidity, snow depth, air quality, sunrise, sunset), (i) imagery data (for example, imagery and light spectrum information from an agricultural apparatus sensor, camera, computer, smartphone, tablet, unmanned aerial vehicle, planes or satellite), (j) scouting observations (photos, videos, free form notes, voice recordings, voice transcriptions, weather conditions (temperature, precipitation (current and over time), soil moisture, crop growth stage, wind velocity, relative humidity, dew point, black layer)), (k) soil, seed, crop phenology, pest and disease reporting, and predictions sources and databases, and (l) other data described herein, etc.

As described, data server 108 is communicatively coupled to the agricultural computer system 116 and is programmed, or configured, to send external data (e.g., data associated with growing spaces, etc.) to agricultural computer system 116 via the network(s) herein. The data server 108 may be owned or operated by the same legal person or entity as the agricultural computer system 116, or by a different person or entity, such as a government agency, non-governmental organization (NGO), and/or a private data service provider. Examples of external data may include location data, weather data, imagery data, soil data, seed data and treatment data as described herein, data from the various growing spaces obtained from the farm equipment 106a-b, or statistical data relating to crop yields, among others (or other data as described herein). External data may include the same type of information as field data. In some embodiments, the external data may also be provided by data server 108 owned by the same entity that owns and/or operates the agricultural computer system 116. For example, the agricultural computer system 116 may include a data server focused exclusively on a type of data that might otherwise be obtained from third-party sources, such as weather data to trial data to treatment data. In some embodiments, data server 108 may be incorporated or integrated, in whole or in part, in the agricultural computer system 116.

The system 100 also includes, as described above, the farm equipment 106a-b configured to plant, treat, or harvest crops from one or more growing spaces (e.g., from one or more of the plots 102, etc.). In some examples, the farm equipment 106a-b may have one or more remote sensors fixed thereon, where the sensor(s) are communicatively coupled, either directly or indirectly, via the farm equipment 106a-b to the agricultural computer system 116 and are programmed, or configured, to send sensor data to agricultural computer system 116.

As described herein, examples of farm equipment 106a-b that may be included in the system 100 include tractors, combines, pickers, sprayers, planters, trucks, fertilizer equipment, aerial vehicles including unmanned aerial vehicles, and any other item of physical machinery or hardware, typically mobile machinery, and which may be used in tasks associated with agriculture and/or related to operations described herein. In some embodiments, the farm equipment can be a handheld phone with a display capable of providing the ability to scout a field. In some embodiments, a single unit of the farm equipment may comprise a plurality of sensors that are coupled locally in a network on the apparatus/equipment. A controller area network (CAN) is an example of such a network that can be installed in combines, harvesters, sprayers, and cultivators. In connection therewith, then, an application controller associated with the apparatus may be communicatively coupled to agricultural computer system 116 via the network(s) and programmed, or configured, to receive one or more scripts (e.g., from the agricultural computer system 116, etc.) that are used to control an operating parameter of the farm equipment 106a-b (or another agricultural vehicle or implement). For instance, a CAN bus interface may be used to enable communications from the agricultural computer system 116 to the farm equipment 106a and/or 106b, for example, such as through the CLIMATE FIELDVIEW DRIVE, available from Climate LLC, Saint Louis, Missouri. Sensor data may consist of the same type of information as field data. In some embodiments, remote sensors may not be fixed to farm equipment but may be remotely located in the field and may communicate with one or more networks of the system 100.

As indicated above, the network(s) of the system 100 are generally illustrated in FIG. 1 by arrowed lines. In connection therewith, the network(s) broadly represent any combination of one or more data communication networks including local area networks, wide area networks, internetworks or internets, using any of wireline or wireless links, including terrestrial or satellite links. The network(s) may be implemented by any medium or mechanism that provides for the exchange of data between the various elements of FIG. 1. The various elements of FIG. 1 may also have direct (wired or wireless) communications links. For instance, the farm equipment 106a-b in the system 100, data server 108, agricultural computer system 116, and other elements of the system 100 may each comprise an interface compatible with the network(s) and programmed, or configured, to use standardized protocols for communication across the networks, such as TCP/IP, Bluetooth, CAN protocol and higher-layer protocols, such as HTTP, TLS, and the like.

That said, the agricultural computer system 116 is programmed, or configured, generally, to receive field data from communication device 104, external data 120 from external data server 122 and/or the data server 108, and sensor data from one or more remote sensors in the system 100. Agricultural computer system 116 may be further configured to host, use, or execute one or more computer programs, other software elements, digitally programmed logic, such as FPGAs or ASICs, or any combination thereof, to perform translation and storage of data values, construction of digital models of one or more crops on one or more fields, generation of recommendations and notifications, and generation and sending of scripts, in the manner described further in other sections of this disclosure.

In an embodiment, agricultural computer system 116 is programmed with or comprises a communication layer 132, a presentation layer 134, a data management layer 140, a hardware/visualization layer 150, and a model and field data repository layer 160. “Layer,” in this context, refers to any combination of electronic digital interface circuits, microcontrollers, firmware, such as drivers, and/or computer programs, or other software elements.

Communication layer 132 may be programmed, or configured, to perform input/output interfacing functions including sending requests to communication device 104, data server 108, and remote sensor(s) for field data, external data, and sensor data, respectively. Communication layer 132 may be programmed, or configured, to send the received data to the model and field data repository layer 160 to be stored as field data (e.g., in agricultural computer system 116, etc.).

Presentation layer 134 may be programmed, or configured, to generate a graphical user interface (GUI) to be displayed on communication device 104 (e.g., to interact with the agricultural computer system 116, to identify the target field(s), to select inputs, etc.), or other computers that are coupled to the agricultural computer system 116 through the network(s). The GUI may comprise controls for inputting data to be sent to the agricultural computer system 116, generating requests for models and/or recommendations, and/or displaying recommendations, notifications, models, and other field data.

Data management layer 140 may be programmed, or configured, to manage read operations and write operations involving the repository layer 160 and other functional elements of the system 100, including queries and result sets communicated between the functional elements of the system and the repository layer 160. Examples of data management layer 140 include JDBC, SQL server interface code, and/or HADOOP interface code, among others. The repository layer 160 may comprise a database. As used herein, the term “database” may refer to either a body of data, a relational database management system (RDBMS), or both. As used herein, a database may comprise any collection of data including hierarchical databases, relational databases, flat file databases, object-relational databases, object-oriented databases, distributed databases, and any other structured collection of records or data that is stored in a computer system. Examples of RDBMS's include, but are not limited to, ORACLE®, MYSQL, IBM® DB2, MICROSOFT® SQL SERVER, SYBASE®, and POSTGRESQL databases. That said, any database may be used that enables the systems and methods described herein.

When field data is not provided directly to the agricultural computer system 116 via farm equipment (e.g., equipment 106a-b, etc.) that interacts with the agricultural computer system 116, the user 103 may be prompted via one or more user interfaces on the communication device 104 (served by the agricultural computer system 116) to input such data to the agricultural computer system 116. In an example embodiment, the user 103 may specify identification data by accessing a map on the communication device 104 (served by the agricultural computer system 116) and selecting specific CLUs that have been graphically shown on the map. In an alternative embodiment, the user 103 may specify data by accessing a map on the communication device 104 (served by the agricultural computer system 116) and drawing boundaries of the field over the map to indicate specific data. Such CLU selection, or map drawings, represent geographic identifiers. In alternative embodiments, the user 103 may specify data by accessing field identification data (provided as shape files or in a similar format) from the U.S. Department of Agriculture Farm Service Agency, or other source, via the communication device 104 and providing such field identification data to the agricultural computer system 116.

In an example embodiment, the agricultural computer system 116 is programmed to generate and cause displaying of a graphical user interface comprising a data manager for data input. After one or more fields (or associated data) have been identified using the methods described above, the data manager may provide one or more graphical user interface widgets which, when selected, can identify changes to the field, soil, crops, tillage, or nutrient practices, and/or which may provide comparison data related to treatments, yields, etc. identified by the disclosure herein for fields of the growing spaces. The data manager may include a timeline view, a spreadsheet view, a graphical view, and/or one or more editable programs.

In an embodiment, model and field data is stored in the model and field data repository layer 160. Model data comprises data models created for one or more fields. For example, a crop model may include a digitally constructed model of the development of a crop on the one or more fields. “Model,” in this context, refers to an electronic digitally stored set of executable instructions and data values, associated with one another, which are capable of receiving and responding to a programmatic or other digital call, invocation, or request for resolution based upon specified input values, to yield one or more stored or calculated output values that can serve as the basis of computer-implemented recommendations, output data displays, or machine control, among other things. Persons of skill in the field find it convenient to express models using mathematical equations, but that form of expression does not confine the models disclosed herein to abstract concepts; instead, each model herein may have a practical application in a computer in the form of stored executable instructions and data that implement the model using the computer. The model may include a model of past events on the one or more fields/plots, a model of the current status of the one or more fields/plots, and/or a model of predicted events on the one or more fields/plots. Model and field data may be stored in data structures in memory, rows in a database table, in flat files or spreadsheets, or other forms of stored digital data.

With reference again to FIG. 1, in an embodiment, instructions 135 of the agricultural computer system 116 may comprise a set of one or more pages of main memory, such as RAM, in the agricultural computer system 116 into which executable instructions have been loaded and which, when executed, cause the agricultural computer system 116 to perform the functions or operations that are described herein. For example, the instructions 135 may comprise a set of pages in RAM that contain instructions which, when executed, cause performing treatment decision functions described herein. The instructions may be in machine executable code in the instruction set of a CPU and may have been compiled based upon source code written in JAVA, C, C++, OBJECTIVE-C, or any other human-readable programming language or environment, alone or in combination with scripts in JAVASCRIPT, other scripting languages, and other programming source text. The term “pages” is intended to refer broadly to any region within main memory and the specific terminology used in a system may vary depending on the memory architecture or processor architecture. In another embodiment, the instructions 135 also may represent one or more files, or projects of source code, that are digitally stored in a mass storage device, such as non-volatile RAM or disk storage, in the agricultural computer system 116 or a separate repository system, which, when compiled or interpreted, cause generating executable instructions which, when executed, cause the agricultural computer system 116 to perform the functions or operations that are described herein. In other words, the drawing figure may represent the manner in which programmers or software developers organize and arrange source code for later compilation into an executable, or interpretation into bytecode or the equivalent, for execution by the agricultural computer system 116.

Hardware/visualization layer 150 comprises one or more central processing units (CPUs), memory controllers, and other devices, components, or elements of a computer system, such as volatile or non-volatile memory, non-volatile storage, such as disk, and I/O devices or interfaces as illustrated and described, for example, in connection with FIG. 5. The hardware/visualization layer 150 also may comprise programmed instructions that are configured to support visualization, virtualization, containerization, or other technologies.

In one embodiment, rulesets may be generated and stored in the data server 108 and/or the external data server 122, which then may be transferred to the agricultural computer system 116 and then be stored in the repository layer 160. For example, the external data server 122 may be owned by an agricultural program administrator. A ruleset implementing the program may be stored in the external data server 122. When the grower or user 103 enrolls his or her farm in the program, the agricultural computer system 116 may establish a communication link to the external data server 122 and the ruleset implementing the program may be sent to the agricultural computer system 116. Alternatively, in another embodiment, the user may generate a ruleset using the communication device 104 and transmit the ruleset to the agricultural computer system 116 using the communication device 104.

In some embodiments, a ruleset may be authored, curated, or otherwise established by an agricultural program administrator or by an owner, operator, or manager acting on behalf of the agricultural program administrator. For example, the program administrator may define compliance parameters, geospatial constraints, timing windows, product label restrictions, recordkeeping requirements, or other prescriptive conditions, and cause a corresponding ruleset to be generated and published to the agricultural computer system 116 and/or to on‑board equipment controllers. In further embodiments, the ruleset may be created at the direction or behest of the program administrator by a designated contractor, employee, or other agent, and thereafter maintained, versioned, and distributed through the same communication pathways described herein so that enrolled growers receive the applicable ruleset when they join or update participation in the program.

Growers and their designees access an interface to create, manage, and monitor the rulesets and rules associated with their fields. This includes a catalog of available pre-defined programs, such as Directo or regenerative agricultural programs, pre-defined crop protection product label rules, along with the ability to draft and publish grower-managed rules. The ruleset catalog will distinguish between broader access rulesets and those “local” rulesets defined by/for a specific grower. Rulesets and rules have defined alerting associated with them, allowing the grower to define if/how notifications occur related to rulesets and/or individual rules and to whom (device/person deviating from the rule, grower, silent, multiple, etc.) and how those alerts should be directed. Rules conformance can occur through geospatial, external data (such as weather conditions and EPA’s PULA), and/or time-based thresholds or behaviors. One example of a time-based behavior is a program that requires a crop protection application within a certain time window. An example of this is a grower or designee defining a rule to alert the grower if a spray application deadline is approaching in a specified number of days and the spray application has not yet occurred. Additionally, the interface will provide growers and their designees robust monitoring and reporting capabilities they oversee so that they can evaluate the status/state of the rulesets and constituent rules within their operation(s). Growers can view and report status on rulesets and based on their state (planned/active/elapsed) and status (in compliance, at risk, out of compliance) and view events/activity in the defined geospatial area(s). Growers and their designees can use the system to input and validate planned farm management operations, such as crop protection applications, harvest plans, tilling plans, etc against rules and rulesets. In doing so, growers and their designees can evaluate whether their desired operational plans are in alignment prior to actually initiating activity. An example of this would be a crop protection application where the grower plans to have an application on one of their fields. They could enter the planned event into the system and perform a precheck to understand if the crop protection application is anticipated to conform to EPA label and PULA restrictions. This functionality is in addition to alerts generated by the system at time of application. Growers and their designees can also generate relevant documentation on field operations to satisfy external party information requirements, including but not limited to obtaining refunds from input providers that sponsor farm management programs and governmental entities such as the EPA.

In one embodiment, rulesets may capture the specific protocol or behavior details that are to be monitored. These can include but are not limited to combinations of time-based, location-based, and behavior-based policies, and may include prior events occurring in the area of interest (i.e. events that occurred prior to enrollment in the agricultural program). Rulesets in this instance may refer to a combination of one or more unique policies. Examples of rulesets include, first, sustainability practice management – compliance with no-till field designation. An agricultural implement’s time-stamped location data (e.g. a combine’s field traversal data) is checked to see if it is traversing a field enrolled in the program between the end of harvest and beginning of planting defined by location and time-based planting windows. If so, the grower is out of compliance. Second, protocol/trial corruption – harvest integrity within an area of interest. Once a particular piece of equipment begins to harvest a field or subfield of interest where a protocol is designated, additional equipment cannot enter the region until the original equipment has completed harvest operations in the region. Third, protocol/trial corruption – farming practice compliance. Rules that implement specific farming practices, such as: a) tillage events preceding or not preceding planting; b) planting occurring within certain parameters, where the parameters may be based on time, agronomic factors, etc.; c) repetitive practice application, such as preventing planting in areas already planted, spraying fungicides in areas already treated, harvesting in areas already harvested, etc.; d) appropriate product being planted or treatment being applied, for example, a region may be designated to grow a certain breed of seed or receive a certain treatment (e.g. pesticide); e) treatments not occurring or occurring within parameters, for example, spraying treatments may be limited to a certain time window; f) harvest occurring within acceptable parameters, for example, harvesting may be limited to a certain time window; g) grower/equipment into area of interest at times not permitted by the protocol/trial, for example, entry into an area of interest with tillage equipment during the time period between harvest and planting. Fourth, safety management – monitoring areas of interest for entry during designated no-go periods around specific farm operations such as limiting area of interest access following the application of crop protection products in alignment with grower, protocol/trial, and/or label restrictions. Fifth, deviation from recommendation – A program administrator may recommend to the grower one or more agricultural practices. For example, the administrator may recommend to the grower to spray a certain quantity of pesticide or other treatment at one or more particular plots or fields during a certain time window. The administrator may generate these recommendations by using one or more models, such as predictive, machine learning, deep learning, or other artificial intelligence models. One such model is disclosed in U.S. Pub. No. 2023/0035413, which is incorporated herein by reference. The grower’s activity can then be monitored to ensure compliance with the recommendations. For example, the grower can be deemed to be out of compliance when data from his or her sprayer show that pesticide spraying occurred outside of the recommended time window.

As explained above, once defined, rulesets are published to the agricultural computer system 116. That is, the rulesets may be transmitted to the agricultural computer system 116 from the external data server 122. The agricultural computer system 116 may then monitor the agricultural implements or farm equipment 106a-b for compliance with the rulesets. Depending on the nature of the rulesets, some policies may require real-time monitoring. In that case, the rulesets may be further transmitted from the agricultural computer system 116 to on-board computer systems in the farm equipment 106a-b. In addition, depending on the nature of the rulesets, some policies may require real-time coordination with other devices, equipment, or personnel on the field and necessitate a network connection to a service to coordinate event or activity sharing. For example, to prevent repetitive or duplicative harvesting, all harvesters may be connected to a service to share their activity and location data in real-time. The agricultural computer system 116 may also be connected to such a service to monitor the harvesters’ activities and locations.

Other rulesets, such as a rule specifying that no tillage equipment should enter into a no-till field between harvest and planting, can be operated fully autonomously within the agricultural equipment 106a-b once the ruleset is loaded into the processor and/or memory of the agricultural equipment 106a-b and would not require a live connection to a service.

Once a ruleset is determined to have been violated, alerts may be provided in real-time. These alerts would be triggered by the agricultural computer system 116 or the agricultural equipment 106a-b themselves, depending on, as explained above, whether the rulesets are published to the agricultural computer system 116 or the agricultural equipment 106a-b. These alerts may alert the operators of the agricultural equipment 106a-b that their activity is potentially impacting a program that has been defined, such that compliance under the program is in question. The alerts can take the form of a visual alert, an auditory alert, a haptic alert or notification, etc. In the case where there is network connectivity, alerts may be sent to multiple parties concurrently. For example, an alert may be sent to both the operator of the agricultural equipment 106b via a screen in the agricultural equipment 106b and the user 103 via the communication device 104.

In sum, a system according to an embodiment of the present disclosure leverages (1) geospatial boundaries that are established for fields, subfields, or testing regions, (2) rulesets related to the geospatial areas of interest that are defined and loaded into the system, and (3) data, including activity and location data, from agricultural equipment. Leveraging these datasets and communication capabilities between computer systems and agricultural equipment, the system may monitor grower behaviors against established rules and generate notification events in real-time to the growers to alert them to potential deviations or compliance violations of the rulesets.

For purposes of illustrating a clear example, FIG. 1 shows a limited number of instances of certain functional elements. However, in other embodiments, there may be any number of such elements. For example, embodiments may use thousands or millions of different mobile computing devices associated with different users/growers. Further, the agricultural computer system 116 and/or data server 108 may be implemented using two or more processors, cores, clusters, or instances of physical machines or virtual machines, configured in a discrete location or co-located with other elements in a datacenter, shared computing facility or cloud computing facility.

In an embodiment, the implementation of the functions described herein using one or more computer programs, or other software elements that are loaded into and executed using one or more general-purpose computers, will cause the general-purpose computers to be configured as a particular machine or as a computer that is specially adapted to perform the functions described herein. Further, each of the flow diagrams that are described further herein may serve, alone or in combination with the descriptions of processes and functions in prose herein, as algorithms, plans, or directions that may be used to program a computer or logic to implement the functions that are described. In other words, all the prose text herein, and all the drawing figures, together are intended to provide disclosure of algorithms, plans, or directions that are sufficient to permit a skilled person to program a computer to perform the functions that are described herein, in combination with the skill and knowledge of such a person given the level of skill that is appropriate for disclosures of this type.

In an embodiment, the user 103 interacts with the agricultural computer system 116 using the communication device 104 configured with an operating system and one or more application programs or apps. The communication device 104 also may interoperate with the agricultural computer system 116 independently and automatically under program control or logical control. Direct user interaction is not always required. The communication device 104 broadly represents one or more of a smartphone, PDA, tablet computing device, laptop computer, desktop computer, workstation, or any other computing device capable of transmitting and receiving information and performing the functions described herein. The communication device 104 may communicate via a network using a mobile application stored on the communication device 104, and in some embodiments, the communication device 104 may be coupled using a cable or connector to one or more sensors and/or other apparatus in the system 100. The particular user 103 may own, operate, or possess and use, in connection with system 100, more than one communication device at a time.

The mobile application associated with the communication device 104 may provide client-side functionality, via the network to one or more mobile computing devices. In an example embodiment, the communication device 104 may access the mobile application via a web browser or a local client application or app. The communication device 104 may transmit data to, and receive data from, one or more front-end servers, using web-based protocols, or formats, such as HTTP, XML, and/or JSON, or app-specific protocols. In an example embodiment, the data may take the form of requests (e.g., for a decision, selection, etc.) and user information input, such as field data, into the mobile computing device. In some embodiments, the mobile application interacts with location tracking hardware and software on the communication device 104 which determines the location of the communication device 104 using standard tracking techniques, such as multilateration of radio signals, the global positioning system (GPS), WiFi positioning systems, or other methods of mobile positioning. In some cases, location data or other data associated with the communication device 104, user 103, and/or user account(s) may be obtained by queries to an operating system of the device or by requesting an app on the device to obtain data from the operating system.

In an embodiment, in addition to other functionalities described herein, the communication device 104 sends field data to agricultural computer system 116 comprising or including, but not limited to, data values representing one or more of: a geographical location of the one or more fields, tillage information for the one or more fields, crops planted in the one or more fields, and soil data extracted from the one or more fields. The communication device 104 may send field data in response to user input from the user 103 specifying the data values for the one or more fields. Additionally, the communication device 104 may automatically send field data when one or more of the data values becomes available to the communication device 104. For example, the communication device 104 may be communicatively coupled to a remote sensor in the system 100, and in response to an input received at the sensor, the communication device 104 may send field data to agricultural computer system 116 representative of the input. Field data identified in this disclosure may be input and communicated using electronic digital data that are communicated between computing devices using parameterized URLs over HTTP, or another suitable communication or messaging protocol. In that sense, in some aspects of the present disclosure, the field data provided by the communication device 104 may also be stored as external data (e.g., where the field data are collected as part of harvesting crops from growing spaces, etc.), for example, in data server 108.

A commercial example of the mobile application described above is CLIMATE FIELDVIEW, commercially available from Climate LLC, Saint Louis, Missouri. The CLIMATE FIELDVIEW application, or other applications, may be modified, extended, or adapted to include features, functions, and programming that have not been disclosed earlier than the filing date of this disclosure. In one embodiment, the mobile application comprises an integrated software platform that allows a grower to make fact-based decisions for their operation because it combines historical data about the grower's fields with any other data that the grower wishes to compare. The combinations and comparisons may be performed in real-time and are based upon scientific models that provide potential scenarios to permit the grower to make better, more informed decisions.

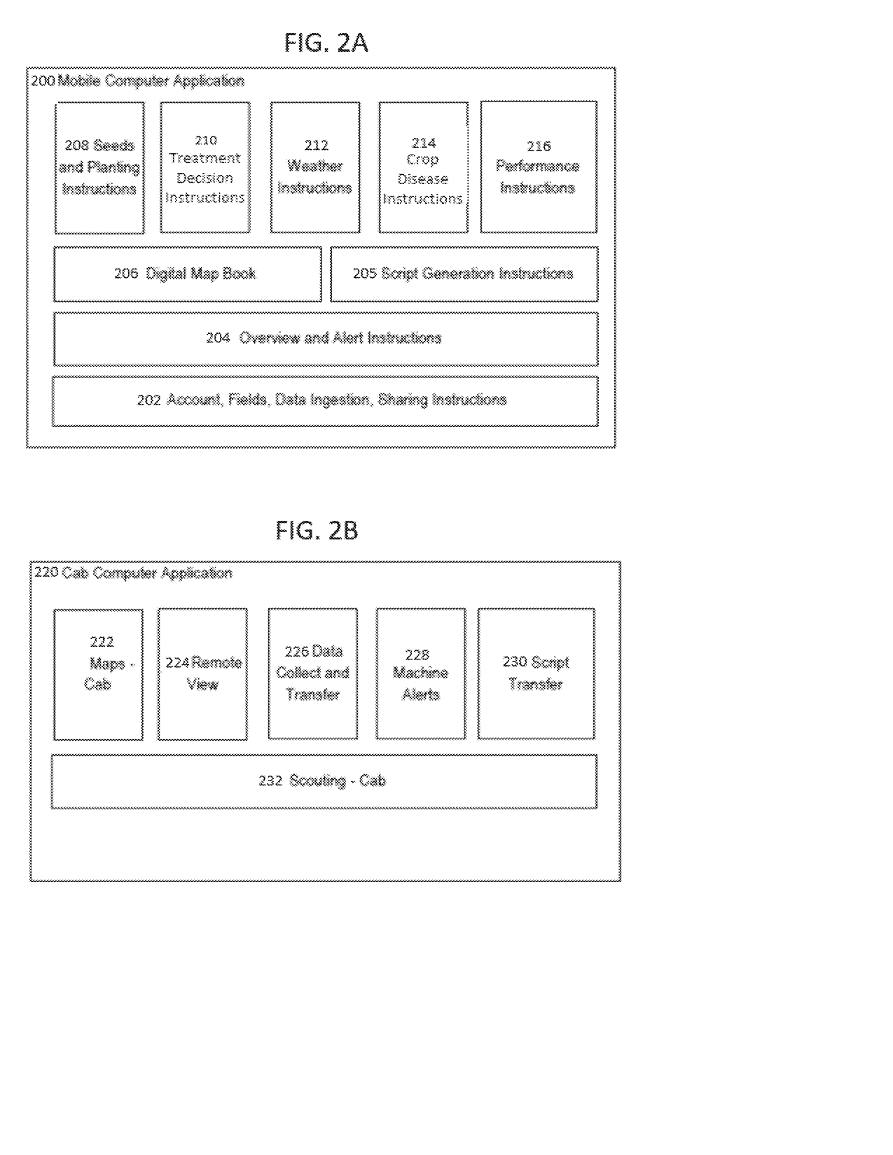

FIGS. 2A-2B illustrate two views of an example logical organization of sets of instructions in main memory when an example mobile application is loaded for execution. Each named element represents a region of one or more pages of RAM, or other main memory, or one or more blocks of disk storage, or other non-volatile storage, and the programmed instructions within those regions. In one embodiment, in FIG. 2A, a mobile computer application 200 comprises account, fields, data ingestion, sharing instructions 202, overview and alert instructions 204, digital map book instructions 206, seeds and planting instructions 208, treatment decision instructions 210, weather instructions 212, crop disease type instructions 214, and performance instructions 216.

In one embodiment, a mobile computer application 200 comprises account, fields, data ingestion, sharing instructions 202 which are programmed to receive, translate, and ingest field data from third-party systems via manual upload or APIs. Data types may include field boundaries, yield maps, as-planted maps, soil test results, as-applied maps, and/or management zones, among others. Data formats may include shape files, native data formats of third parties, and/or farm management information system (FMIS) exports, among others. Receiving data may occur via manual upload, e-mail with attachment, external APIs that push data to the mobile application, or instructions that call APIs of external systems to pull data into the mobile application. In one embodiment, mobile computer application 200 comprises a data inbox. In response to receiving a selection of the data inbox, the mobile computer application 200 may display a graphical user interface for manually uploading data files and importing uploaded files to a data manager.

In one embodiment, digital map book instructions 206 comprise field map data layers stored in device memory and are programmed with data visualization tools and geospatial field notes. This provides growers with convenient information close at hand for reference, logging, and visual insights into field performance and other options provided herein. In one embodiment, overview and alert instructions 204 are programmed to provide an operation-wide view of what is important to the grower, and timely recommendations to take action or focus on particular issues. This permits the grower to focus time on what needs attention, to save time and preserve yield throughout the season. In one embodiment, seeds and planting instructions 208 are programmed to provide tools for seed selection, hybrid placement, and script creation, including variable rate (VR) script creation, based upon scientific models and empirical data. This enables growers to maximize yield, or return on investment, through optimized seed purchase, placement, and population.

In one embodiment, script generation instructions 205 are programmed to provide an interface for generating scripts, including variable rate (VR) fertility scripts. The interface enables growers to create scripts for field implements, such as treatment decisions, planting, and irrigation. For example, a planting script interface may comprise tools for identifying a type of seed for planting. Upon receiving a selection of the seed type, mobile computer application 200 may display one or more fields broken into management zones, such as the field map data layers created as part of digital map book instructions 206. In one embodiment, the management zones comprise soil zones along with a panel identifying each soil zone and a soil name, texture, drainage for each zone, or other field data. Mobile computer application 200 may also display tools for editing or creating, such as graphical tools for drawing management zones, such as soil zones, over a map of one or more fields. Planting procedures may be applied to all management zones or different planting procedures may be applied to different subsets of management zones. When a script is created, mobile computer application 200 may make the script available for download in a format readable by an application controller, such as an archived or compressed format. Additionally, and/or alternatively, a script may be sent directly to a cab computer (e.g., associated with farm equipment 106a and/or 106b, etc.) from mobile computer application 200 and/or uploaded to one or more data servers and stored for further use.

In one embodiment, treatment decision instructions 210 are programmed to provide tools to inform decisions by visualization or instruction about the application of one or more candidate treatments to crops in a particular field. This enables growers to potentially enhance yield or return on investment through treatment application during the season.

Example programmed functions include displaying images to enable tuning application(s) of treatment across multiple zones; output of scripts to drive machinery; tools for mass data entry and adjustment; and/or maps for data visualization, among others. Treatment decision instructions 210 also may be programmed to generate and cause displaying a treatment graph, indicative of the application of the treatment to one or more target fields, but not others based on the functions explained herein. In one embodiment, the treatment graph may include one or more user input features, such as dials or slider bars, to dynamically change the candidate treatment programs so that the grower may alter the parameters of the treatment decision. Treatment instructions 210 also may be programmed to generate and cause displaying a treatment decision or indications.

In one embodiment, weather instructions 212 are programmed to provide field-specific recent weather data and forecasted weather information. This enables growers to save time and have an efficient integrated display with respect to daily operational decisions.

In one embodiment, crop disease type instructions 214 are programmed to provide timely remote sensing images highlighting in-season crop variation, multiple crop disease types, and potential concerns. Example programmed functions include cloud checking, to identify possible clouds or cloud shadows; determining treatment indices based on field images; graphical visualization of scouting layers, including, for example, those related to field health, and viewing and/or sharing of scouting notes; recording observations of different crop disease type presence and/or severity; and/or downloading satellite images from multiple sources and prioritizing the images for the grower, among others.

In one embodiment, performance instructions 216 are programmed to provide reports, analysis, and insight tools using on-farm data for evaluation, insights, and decisions. This enables the grower to seek improved outcomes for the next year through fact-based conclusions about why return on investment was at prior levels, and insight into yield-limiting factors. The performance instructions 216 may be programmed to communicate via the network(s) to back-end analytics programs executed at agricultural computer system 116 and/or data server 108 and configured to analyze metrics, such as yield, yield differential, hybrid, population, SSURGO zone, soil test properties, or elevation, among others. Programmed reports and analysis may include yield variability analysis, treatment effect estimation, benchmarking of yield and other metrics against other growers based on anonymized data collected from many growers, or data for seeds and planting, among others.

Applications having instructions configured in this way may be implemented for different computing device platforms while retaining the same general user interface appearance. For example, the mobile application may be programmed for execution on tablets, smartphones, or server computers that are accessed using browsers at client computers. Further, the mobile application as configured for tablet computers or smartphones may provide a full app experience, or a cab app experience, that is suitable for the display and processing capabilities of a cab computer (e.g., associated with farm equipment 106a and/or 106b, etc.). For example, referring now to FIG. 2B, in one embodiment a cab computer application 220 (e.g., as accessible in one of farm equipment 106a, 106b, etc.) may comprise maps-cab instructions 222, remote view instructions 224, data collect and transfer instructions 226, machine alerts instructions 228, script transfer instructions 230, and scouting-cab instructions 232. The code base for the instructions of FIG. 2B may be the same as for FIG. 2A and executables implementing the code may be programmed to detect the type of platform on which they are executing and to expose, through a graphical user interface, only those functions that are appropriate to a cab platform or full platform. This approach enables the system to recognize the distinctly different user experience that is appropriate for an in-cab environment and the different technology environment of the cab. The maps-cab instructions 222 may be programmed to provide map views of fields, farms, or regions that are useful in directing machine operation. The remote view instructions 224 may be programmed to turn on, manage, and provide views of machine activity in real-time or near real-time to other computing devices connected to the agricultural computer system 116 via wireless networks, wired connectors or adapters, and the like. The data collect and transfer instructions 226 may be programmed to turn on, manage, and provide transfer of data collected at sensors and controllers to the agricultural computer system 116 via wireless networks, wired connectors or adapters, and the like (e.g., via network(s) in the system 100, etc.). The machine alerts instructions 228 may be programmed to detect issues with operations of the machines or tools that are associated with the cab and generate operator alerts. The script transfer instructions 230 may be configured to transfer in scripts of instructions that are configured to direct machine operations or the collection of data. The scouting-cab instructions 232 may be programmed to display location-based alerts and information received from the agricultural computer system 116 based on the location of the communication device 104, farm equipment 106a-b, or sensors in the field (of the growing spaces) and ingest, manage, and provide transfer of location-based scouting observations to the agricultural computer system 116 based on the location of the farm equipment 106a-b, or sensors in the field.

In an embodiment, data server 108 stores external data 120 from the data server 122, including soil data representing soil composition for the one or more fields and weather data representing temperature and precipitation on the one or more fields (and/or other data). The weather data may include past and present weather data as well as forecasts for future weather data. In an embodiment, data server 108 comprises a plurality of servers hosted by different entities. For example, a first server may contain soil composition data while a second server may include weather data. Additionally, soil composition data may be stored in multiple servers. For example, one server may store data representing percentage of sand, silt, and clay in the soil while a second server may store data representing percentage of organic matter (OM) in the soil. Further, in some embodiments, the data server 108, again, may include data associated with the growing spaces with regard to available seeds for use in comparisons, etc.

In an embodiment, remote sensors in the system 100 may comprise one or more sensors that are programmed, or configured, to produce one or more observations related to growing spaces, trials therein, etc. Remote sensors may be aerial sensors, such as satellites, vehicle sensors, planting equipment sensors, tillage sensors, fertilizer or insecticide application sensors, harvester sensors, and any other implement capable of receiving data from the one or more fields (e.g., associated with one or more of the growing spaces, etc.). In an embodiment, farm equipment 106a-b may include an application controller programmed, or configured, to receive instructions from agricultural computer system 116. The application controller may also be programmed, or configured, to control an operating parameter of the farm equipment 106a-b. Other embodiments may use any combination of sensors and controllers, of which the following are merely selected examples.

The system 100 may obtain or ingest data under grower control, on a mass basis from a large number of growers who have contributed trial data or other data to a shared database system. This form of obtaining data may be termed “manual data ingest” as one or more user-controlled computer operations are requested, or triggered, to obtain data for use by the agricultural computer system 116. As an example, the CLIMATE FIELDVIEW application, commercially available from Climate LLC, Saint Louis, Missouri, may be operated to export data to agricultural computer system 116 for storing in the field data repository 160.

For example, seed monitor systems can both control planter apparatus components and obtain planting data, including signals from seed sensors via a signal harness that comprises a CAN backbone and point-to-point connections for registration and/or diagnostics. Seed monitor systems can be programmed, or configured, to display seed spacing, population, and other information to the user via a cab computer of the apparatus, or other devices within the system 100.

Likewise, yield monitor systems may contain yield sensors for harvester apparatus that send yield measurement data to a cab computer of the apparatus, or other devices within the system 100. Yield monitor systems may utilize one or more remote sensors to obtain grain moisture measurements in a combine, or other harvester, and transmit these measurements to the user 103 via the cab computer, or other devices within the system 100.

In an embodiment, examples of sensors that may be used with any moving vehicle, or apparatus of the type described elsewhere herein, include kinematic sensors and position sensors. Kinematic sensors may comprise any of speed sensors, such as radar or wheel speed sensors, accelerometers, or gyros. Position sensors may comprise GPS receivers or transceivers, or WiFi-based position or mapping apps that are programmed to determine location based upon nearby WiFi hotspots, among others.

In an embodiment, examples of sensors that may be used with tractors, or other moving vehicles, include engine speed sensors, fuel consumption sensors, area counters or distance counters that interact with GPS or radar signals, PTO (power take-off) speed sensors, tractor hydraulics sensors configured to detect hydraulics parameters, such as pressure or flow, and/or and hydraulic pump speed, wheel speed sensors or wheel slippage sensors. In an embodiment, examples of controllers that may be used with tractors include hydraulic directional controllers, pressure controllers, and/or flow controllers; hydraulic pump speed controllers; speed controllers or governors; hitch position controllers; or wheel position controllers provide automatic steering.

In an embodiment, examples of sensors that may be used with seed planting equipment, such as planters, drills, or air seeders, include seed sensors, which may be optical, electromagnetic, or impact sensors; downforce sensors, such as load pins, load cells, pressure sensors; soil property sensors, such as reflectivity sensors, moisture sensors, electrical conductivity sensors, optical residue sensors, or temperature sensors; component operating criteria sensors, such as planting depth sensors, downforce cylinder pressure sensors, seed disc speed sensors, seed drive motor encoders, seed conveyor system speed sensors, or vacuum level sensors; or pesticide application sensors, such as optical or other electromagnetic sensors, or impact sensors. In an embodiment, examples of controllers that may be used with such seed planting equipment include: toolbar fold controllers, such as controllers for valves associated with hydraulic cylinders; downforce controllers, such as controllers for valves associated with pneumatic cylinders, airbags, or hydraulic cylinders, and programmed for applying downforce to individual row units or an entire planter frame; planting depth controllers, such as linear actuators; metering controllers, such as electric seed meter drive motors, hydraulic seed meter drive motors, or swath control clutches; hybrid selection controllers, such as seed meter drive motors, or other actuators programmed for selectively allowing or preventing seed or an air-seed mixture from delivering seed to or from seed meters or central bulk hoppers; metering controllers, such as electric seed meter drive motors, or hydraulic seed meter drive motors; seed conveyor system controllers, such as controllers for a belt seed delivery conveyor motor; marker controllers, such as a controller for a pneumatic or hydraulic actuator; or pesticide application rate controllers, such as metering drive controllers, orifice size or position controllers.

In an embodiment, examples of sensors that may be used with tillage equipment include position sensors for tools, such as shanks or discs; tool position sensors for such tools that are configured to detect depth, gang angle, or lateral spacing; downforce sensors; or draft force sensors. In an embodiment, examples of controllers that may be used with tillage equipment include downforce controllers or tool position controllers, such as controllers configured to control tool depth, gang angle, or lateral spacing.

In an embodiment, examples of sensors that may be used in relation to an apparatus for applying fertilizer, insecticide, fungicide, herbicide, and the like, such as on-planter starter fertilizer systems, subsoil fertilizer applicators, or fertilizer sprayers, include: fluid system criteria sensors, such as flow sensors or pressure sensors; sensors indicating which spray head valves or fluid line valves are open; sensors associated with tanks, such as fill level sensors; sectional or system-wide supply line sensors, or row-specific supply line sensors; or kinematic sensors, such as accelerometers disposed on sprayer booms. In an embodiment, examples of controllers that may be used with such apparatus include pump speed controllers; valve controllers that are programmed to control pressure, flow, direction, PWM and the like; or position actuators, such as for boom height, subsoiler depth, or boom position.

In an embodiment, examples of sensors that may be used with harvesters include yield monitors, such as impact plate strain gauges or position sensors, capacitive flow sensors, load sensors, weight sensors, or torque sensors associated with elevators or augers, or optical or other electromagnetic grain height sensors; grain moisture sensors, such as capacitive sensors; grain loss sensors, including impact, optical, or capacitive sensors; header operating criteria sensors, such as header height, header type, deck plate gap, feeder speed, and reel speed sensors; separator operating criteria sensors, such as concave clearance, rotor speed, shoe clearance, or chaffer clearance sensors; auger sensors for position, operation, or speed; or engine speed sensors. In an embodiment, examples of controllers that may be used with harvesters include header operating criteria controllers for elements, such as header height, header type, deck plate gap, feeder speed, or reel speed; separator operating criteria controllers for features such as concave clearance, rotor speed, shoe clearance, or chaffer clearance; or controllers for auger position, operation, or speed.

In an embodiment, examples of sensors that may be used with grain carts include weight sensors, or sensors for auger position, operation, or speed. In an embodiment, examples of controllers that may be used with grain carts include controllers for auger position, operation, or speed.

In an embodiment, examples of sensors and controllers may be installed in unmanned aerial vehicle (UAV) apparatus or “drones.” Such sensors may include cameras with detectors effective for any range of the electromagnetic spectrum including visible light, infrared, ultraviolet, near-infrared (NIR), and the like; accelerometers; altimeters; temperature sensors; humidity sensors; pitot tube sensors or other airspeed or wind velocity sensors; battery life sensors; or radar emitters and reflected radar energy detection apparatus; other electromagnetic radiation emitters and reflected electromagnetic radiation detection apparatus. Such controllers may include guidance or motor control apparatus, control surface controllers, camera controllers, or controllers programmed to turn on, operate, obtain data from, manage, and configure any of the foregoing sensors.

In an embodiment, sensors and controllers may be affixed to a soil sampling and measurement apparatus that is configured, or programmed, to sample soil and perform soil chemistry tests, soil moisture tests, and other tests pertaining to soil.

In an embodiment, sensors and controllers may comprise weather devices for monitoring weather conditions of fields.

According to one example embodiment, the techniques described herein are implemented by one or more special-purpose computing devices. The special-purpose computing devices may be hard-wired to perform the techniques, or may include digital electronic devices, such as one or more application-specific integrated circuits (ASICs) or field-programmable gate arrays (FPGAs), that are persistently programmed to perform the techniques, or may include one or more general-purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be a desktop computer systems, portable computer systems, handheld devices, networking devices, or any other device that incorporates hard-wired and/or program logic to implement the techniques.

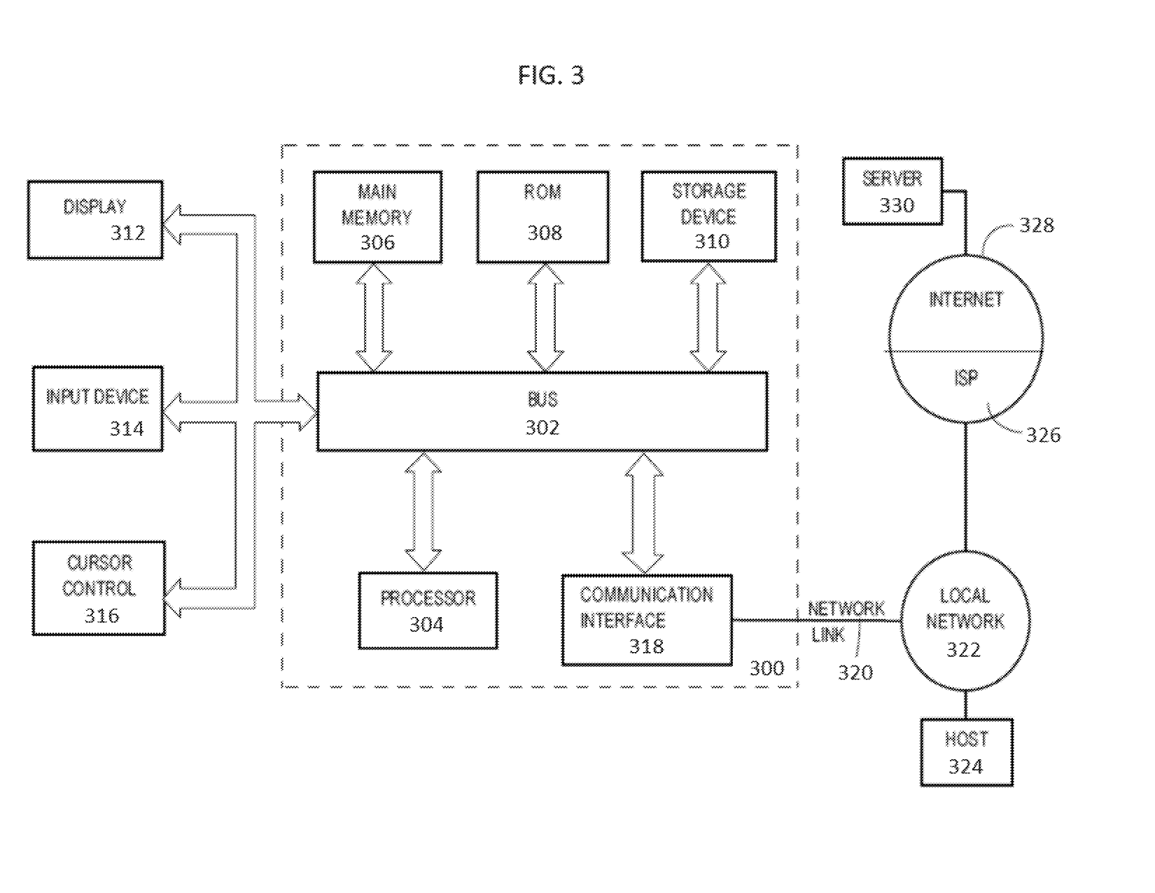

For example, FIG. 3 is a block diagram that illustrates a computer system 300 upon which embodiments of the present disclosure may be implemented. Computer system 300 includes a bus 302 or other communication mechanism for communicating information, and a hardware processor 304 coupled with bus 302 for processing information. Hardware processor 304 may be, for example, a general-purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read-only memory (ROM) 308, or other static storage device coupled to bus 302, for storing static information and instructions for processor 304. A storage device 310, such as a magnetic disk, optical disk, or solid-state drive, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes: a first axis (e.g., x, etc.) and a second axis (e.g., y, etc.), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of, or in combination with, software instructions.

The term “storage media” as used herein refers to any non-transitory media that stores data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, an EPROM, a FLASH-EPROM, NVRAM, or any other memory chip or cartridge.

Storage media is distinct from, but may be used in conjunction with, transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infrared data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infrared signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

With that said, it should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

Examples and embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more example embodiments disclosed herein may provide all or none of the above mentioned advantages and improvements and still fall within the scope of the present disclosure.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may also be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1 – 10, or 2 – 9, or 3 – 8, it is also envisioned that Parameter X may have other ranges of values including 1 – 9, 1 – 8, 1 – 3, 1 - 2, 2 – 10, 2 – 8, 2 – 3, 3 – 10, and 3 – 9.

The terminology used herein is for the purpose of describing particular example embodiments only and is not intended to be limiting. As used herein, the singular forms "a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system for monitoring compliance of an agricultural program comprising:
at least one first processor;
a communication interface communicatively coupled with the at least one first processor and configured to enable communication between the at least one first processor and one or more agricultural implements; and
a first memory communicatively coupled to the at least one first processor, the first memory storing executable instructions, which when executed by the at least one first processor, cause the at least one first processor to:
receive a ruleset corresponding to the agricultural program;
receive first activity and/or location data from at least one of the one or more agricultural implements;
compare the first activity and/or location data against the ruleset to determine whether the at least one of the one or more agricultural implements is in compliance with the agricultural program; and
transmit a command to the at least one of the one or more agricultural implements to generate an alert when the at least one of the one or more agricultural implements is determined to be out of compliance.

2. The system of claim 1, wherein the ruleset is received from:
an external server in communication with the communication interface; or
a communication device in communication with the communication interface and operated by a user.

3. The system of claim 1, wherein the at least one first processor is configured to determine whether the at least one of the one or more agricultural implements traverses a field between an end of harvest and a beginning of planting.

4. The system of claim 1, wherein the at least one first processor is configured to determine whether the at least one of the one or more agricultural implements traverses a field to perform an operation already undertaken by another one of the one or more agricultural implements.

5. The system of claim 1, wherein the at least one first processor is configured to determine whether the at least one of the one or more agricultural implements traverses a restricted field.

6. The system of claim 1, wherein the first memory stores further executable instructions, which when executed by the at least one first processor, cause the at least one first processor to transmit the ruleset to another one of the one or more agricultural implements; and
wherein the other one of the one or more agricultural implements comprises at least one second processor and a second memory communicatively coupled to the at least one second processor, the second memory storing executable instructions, which when executed by the at least one second processor, cause the at least one second processor to:
compare second activity and/or location data of the other one of the one or more agricultural implements against the ruleset to determine whether the other one of the one or more agricultural implements is in compliance with the agricultural program; and
generate an alert when the other one of the one or more agricultural implements is determined to be out of compliance.

7. The system of claim 1, wherein the first memory stores further executable instructions, which when executed by the at least one first processor, cause the at least one first processor to transmit the ruleset to at least two of the one or more agricultural implements; and
wherein a network connection is established between the at least two of the one or more agricultural implements and the at least one first processor to enable data sharing, such that activities of the at least two of the one or more agricultural implements are monitored by the at least one first processor and/or on-board processors of the at least two of the one or more agricultural implements in real-time.

8. The system of claim 1, wherein the alert is a visual alert, an auditory alert, and/or a haptic alert.

9. The system of claim 1, wherein the ruleset defines an activity region where an agricultural activity is to take place, and a control region where the agricultural activity is prohibited, and
wherein the first memory stores boundary information of the activity region and the control region.

10. The system of claim 1, wherein the interface provides growers the monitoring and reporting capability to meet external party requirements.

11. A computer-implemented method for monitoring compliance of an agricultural program comprising:
receiving a ruleset corresponding to the agricultural program and storing the ruleset in a memory communicatively coupled to at least one processor;
receiving first activity and/or location data from at least one of one or more agricultural implements, through a communication interface communicatively coupled with the at least one processor and configured to enable communication between the at least one processor and the one or more agricultural implements;
comparing the first activity and/or location data against the ruleset to determine whether the at least one of the one or more agricultural implements is in compliance with the agricultural program; and
transmitting a command to the at least one of the one or more agricultural implements to generate an alert when the at least one of the one or more agricultural implements is determined to be out of compliance.

12. The method of claim 11, wherein the ruleset is received from:
an external server in communication with the communication interface; or
a communication device in communication with the communication interface and operated by a user.

13. The method of claim 11, wherein in comparing the first activity and/or location data against the ruleset, the method further comprises determining whether the at least one of the one or more agricultural implements traverses a field between an end of harvest and a beginning of planting.

14. The method of claim 11, wherein in comparing the first activity and/or location data against the ruleset, the method further comprises determining whether the at least one of the one or more agricultural implements traverses a field to perform an operation already undertaken by another one of the one or more agricultural implements.

15. The method of claim 11, wherein in comparing the first activity and/or location data against the ruleset, the method further comprises determining whether the at least one of the one or more agricultural implements traverses a restricted field.

16. The method of claim 11, further comprising transmitting the ruleset to another one of the one or more agricultural implements, wherein the other one of the one or more agricultural implements performs the operations of:
comparing second activity and/or location data of the other one of the one or more agricultural implements against the ruleset to determine whether the other one of the one or more agricultural implements is in compliance with the agricultural program; and
generating an alert when the other one of the one or more agricultural implements is determined to be out of compliance.

17. The method of claim 11, further comprising transmitting the ruleset to at least two of the one or more agricultural implements, wherein a network connection is established between the at least two of the one or more agricultural implements and the at least one processor to enable data sharing, such that activities of the at least two of the one or more agricultural implements are monitored by the at least one processor and/or on-board processors of the at least two of the one or more agricultural implements in real-time.

18. The method of claim 11, wherein the alert is a visual alert, an auditory alert, and/or a haptic alert.

19. The method of claim 11, wherein the ruleset defines an activity region where an agricultural activity is to take place, and a control region where the agricultural activity is prohibited, and
wherein the memory stores boundary information of the activity region and the control region.

20. A non-transitory computer-readable storage medium including computer-executable instructions for monitoring compliance of an agricultural program, which when executed by at least one processor, cause the at least one processor to:
receive a ruleset corresponding to the agricultural program;
receive activity and/or location data from at least one of one or more agricultural implements;
compare the activity and/or location data against the ruleset to determine whether the at least one of the one or more agricultural implements is in compliance with the agricultural program; and
transmit a command to the at least one of the one or more agricultural implements to generate an alert when the at least one of the one or more agricultural implements is determined to be out of compliance.
